(19) United States
(12) Patent Application Publication
(10) Pub. No.: US 2014/0151478 A1
(43) Pub. Date: Jun. 5, 2014

(54) CLASSIFIER AND A METHOD OF MODIFYING A CLASSIFIER FOR USE WITH A PULVERISER

(71) Applicant: COAL MILLING PROJECTS (PTY) LIMITED, Johannesburg (ZA)

(72) Inventor: Pierre Goosen, Port Elizabeth (ZA)

(73) Assignee: COAL MILLING PROJECTS (PTY) LIMITED, Johannesburg (ZA)

(21) Appl. No.: 14/096,401

(22) Filed: Dec. 4, 2013

(30) Foreign Application Priority Data
Dec. 5, 2012 (ZA) 2012/09191

(51) Int. Cl. B02C 23/12

(52) U.S. Cl. CPC B02C 23/12
USPC 241/52; 29/401.1

(57) ABSTRACT

The invention relates to a classifier 10 for use with a pulveriser which pulverises raw material. The classifier 10 classifies crushed material into a fine fraction which is expelled via an upper fuel outlet 33 and a coarse fraction which is returned to the pulveriser via a lower rejection outlet 44 for further crushing. The classifier 10 has an internal housing 20 which defines a classification zone 25 and a plurality of triangular flaps 39, each of which are pivotally attached to the housing 20. The flaps 39 are displaceable between a closed position in which they are arranged alongside one another such that sides of adjacent flaps 39 are in abutment and they together define a skirt having a continuous periphery; and an open position in which the flaps 39 are outwardly displaced, widening the outlet 44 in order to allow built-up coarse material to be discharged.

### FIELD OF INVENTION

This invention relates generally to pulverisers or mills used to crush or grind raw material such as fossil fuels into fine particles suitable for combustion in steam-generating furnaces of fossil fuel power plants. More particularly, this invention relates to a classifier attached to such a pulveriser for classifying crushed particulate material received from the pulveriser into a sufficiently fine fraction which is suitable for combustion and a coarse fraction which is rejected and returned to the pulveriser.

### BACKGROUND OF INVENTION

Particle classifiers as identified above are well known in the art and the operation of such classifiers will therefore not be expounded upon in detail below. Known configurations of such classifiers have a drawback in that sometimes foreign objects such as rags, plastic bottles and the like, which are introduced into a pulveriser together with raw material fed into the pulveriser for crushing, find their way into the classifier attached to the pulveriser and in many instances end up blocking or obstructing a rejection outlet of the classifier through which a coarse fraction of the classified particulate material is to be returned to the pulveriser for regrinding. The reason being that in a first known prior art configuration, a rejection gate is rigid defining a fixed annular gap or outlet which is easily obstructed by foreign objects. In a further known prior art configuration, the rejection gate includes a plurality of partitions which define a series of angularly spaced apart closable openings through which the coarse fraction is rejected. A problem with this configuration is that the partitions themselves obstruct the flow of material and foreign objects from the openings which leads to blockages.

Obstruction of the rejection outlet leads to a build-up of particulate material within the classifier which creates the following problems. First, the classification action of the classifier is negatively affected which results in coarse fuel particles being conveyed through to the furnace for combustion. Coarse fuel particles conveyed to the furnace take longer to combust and burn out later in the furnace causing heat damage to components. Furthermore, incomplete combustion of the fuel leads to a drop in efficiency. Blockage of the rejection outlet results in production loss as grinding needs to be halted in order to clear the obstruction. It also poses a safety risk to personnel involved in unblocking a jammed outlet.

The Applicant desires a classifier and a rejection gate which at least ameliorate some of the drawbacks discussed above.

### SUMMARY OF INVENTION

According to a first aspect of the invention, there is provided a classifier for use with a pulveriser which pulverises raw material, the classifier being operable to classify crushed particulate material received from the pulveriser into a fine fraction which is expelled from the classifier and a coarse fraction which is returned to the pulveriser for further crushing, the classifier including:
an external housing;
an internal housing, disposed at least partially within the external housing, the internal housing defining an inward classification zone and further including:
   an airflow inlet for receiving a pulveriser airstream containing crushed particulate material from the pulveriser into the classification zone;
   at least one operatively upper exit; and
   at least two articulated closure members which define a rejection outlet operatively below the exit, the classifier being configured to subject the pulveriser airstream to classification action within the classification zone such that a fine fraction of the pulveriser airstream is expelled from the classifier via the exit and a coarse fraction of the pulveriser airstream is rejected and returned to the pulveriser via the rejection outlet,
      wherein the closure members are displaceable relative to the internal housing between:
a closed position in which the closure members are arranged alongside one another such that sides of adjacent closure members are in abutment and the closure members together define a depending skirt which has a continuous, operatively lower periphery and a cross-sectional area of the rejection outlet is at a minimum; and
an open position in which the sides of adjacent closure members are not in abutment and the cross-sectional area of the rejection outlet is increased.

The classifier may include biasing means for biasing the closure members to the closed position.

The biasing means may be in the form of a plurality of counter weights which are attached to the closure members and are configured to hold the closure members in the closed position when no other forces apart from gravity are applied to the closure members.

Each counter weight may be attached to an operatively outer surface of one closure member, the counter weight extending lengthwise along the outer surface and having a slender transverse cross-sectional surface area in order to minimise air flow restriction.

Furthermore, each closure member may have a wedge-shaped load-bearing face which operatively faces inward. A wide end of the load-bearing face of each closure member may be pivotally connected to a lower periphery of the internal housing, the closure members being outwardly pivotally displaceable relative to the internal housing, from the closed position to the open position, when a load of material having a weight which exceeds a predetermined threshold bears down upon the closure members.

The closure members may be angularly spaced relative to one another about a central axis.

In the closed position, the closure members may be inwardly inclined such that the load bearing faces of the closure members give rise to a continuous skirt which exhibits a frusto-conical profile when seen in longitudinal cross-section.

Sides of adjacent closure members may form a seal between them when in the closed position.

The classifier may include a feed pipe coaxially arranged about an inlet axis, the feed pipe being operable to pass raw material to the pulveriser. The feed pipe may include an outwardly and downwardly projecting flange toward an operatively lower end of the pipe. The closure members may be concentrically arranged around the feed pipe such that the projecting flange and closure members together define a ring-like or annular rejection outlet when the closure members are in the closed position. In a different embodiment, the rejection outlet between the closure members and the projecting flange may be closed when the closure members are in the closed position. The size of the rejection outlet may vary depending on the type of raw material being pulverised. In the case of coal, the rejection outlet may be between 40 mm and 100 mm in breadth.

The classifier may be in the form of a static or dynamic classifier.

According to a second aspect of the invention, there is provided a method of modifying a classifier for use with a pulveriser, the classifier being operable to classify crushed particulate material received from the pulveriser into a fine fraction which is expelled from the classifier and a coarse fraction which is returned to the pulveriser for further crushing, the classifier including:
an external housing;
an internal housing, disposed at least partially within the external housing, the internal housing defining an inward classification zone and further including:
   an airflow inlet for receiving a pulveriser airstream containing crushed particulate material from the pulveriser into the classification zone;
   at least one operatively upper exit; and
   a rejection outlet, arranged operatively below the exit, the method including:
retrofitting at least two articulated closure members to a lower region of the classifier at or toward the rejection outlet, wherein the closure members are displaceable relative to the lower region of the classifier between:
   a closed position in which the closure members are arranged side-by-side such that adjacent sides of the closure members are in abutment and a cross-sectional area of the rejection outlet is at a minimum; and
   an open position in which the adjacent sides of the closure members are not in abutment and the cross-sectional area of the rejection outlet is increased.

The method may include pivotally attaching each of the at least two closure members to a lower region of the classifier at or toward the rejection outlet.

The method may further include biasing the closure members toward their closed position by applying at least one weight to each articulated closure member.

The invention extends to a self-cleaning, load operated rejection gate for a particle classifier, the rejection gate being configured for connection to an operatively lower part of a particle classifier in a configuration in which the gate, together with the classifier, defines a rejection outlet, and in which the rejection gate is movable relative to the classifier between a closed position and an open position, the rejection gate including:
a plurality of closure members which, when the gate is in the closed position, are arranged alongside one another in a configuration in which:
   sides of adjacent closure members are in abutment such that the closure members collectively define a depending skirt which has a continuous, operatively lower periphery; and
   a cross-sectional area of the rejection outlet is at a minimum; and, when the rejection gate is in the open position, sides of adjacent closure members are not in abutment and the cross-sectional area of the rejection outlet is increased.

The invention extends to a pulveriser or mill which includes a classifier as described above.

### BRIEF DESCRIPTION OF DRAWINGS

The invention will now be further described, by way of example, with reference to the accompanying drawings.

In the drawings:

FIG. 1 shows a three-dimensional view of a classifier in accordance with the invention, a rejection gate of the classifier being illustrated in a closed position;

FIG. 2 shows a longitudinal section through the classifier of FIG. 1;

FIG. 3 shows a partial sectional view of the classifier of FIG. 2 on an enlarged scale, focussing in particular on the rejection gate;

FIG. 4 shows a side view of the classifier of FIG. 1 with the rejection gate in an open position;

FIG. 5 shows a longitudinal section through part of the classifier shown in FIG. 4, again focussing on the rejection gate; and

FIG. 6 shows a longitudinal section through part of a further embodiment of the classifier in accordance with the invention.

### DETAILED DESCRIPTION OF AN EXAMPLE EMBODIMENT

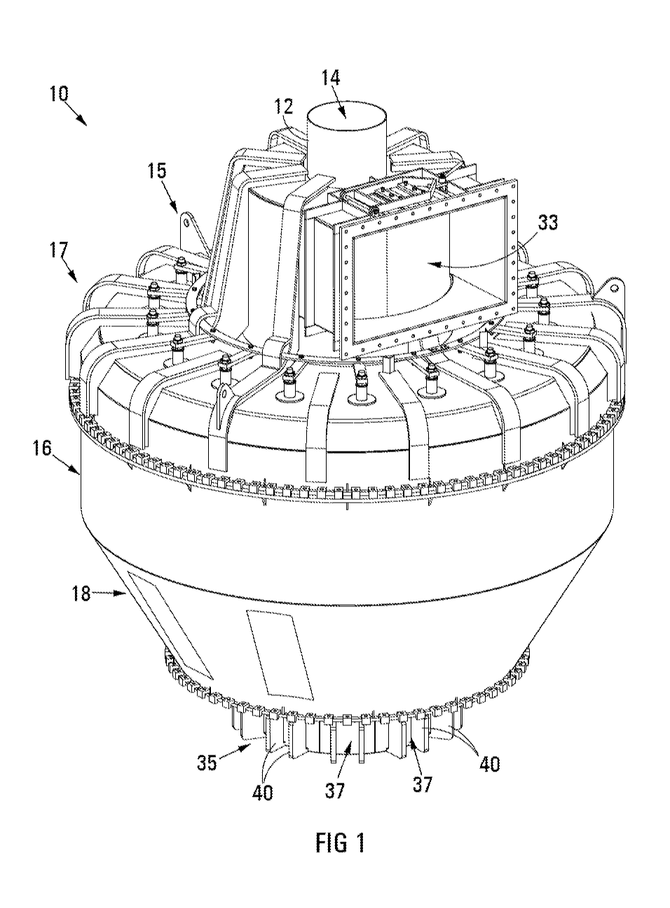

In FIGS. 1 to 4, reference numeral 10 refers generally to a first embodiment of a classifier in accordance with the invention. The classifier 10 includes a cylindrical feed pipe 12 which extends lengthwise through the middle of the classifier 10 and defines a feed inlet 14 toward an operatively upper end of the pipe 12. Raw material, for example coal, received into the feed pipe 12 via the feed inlet 14 is passed through the classifier 10 along an inlet axis X of the feed pipe 12 to a pulveriser positioned below the classifier 10. In the accompanying drawings the pulveriser is not shown. The classifier 10 further includes an external housing which comprises an upper part 15 and a frusto-conical lower part 18. The upper part 15 comprises a generally cylindrical lower region 16, which is connected to the frusto-conical lower part 18 of the external housing, and a roughly dome-shaped upper region 17.

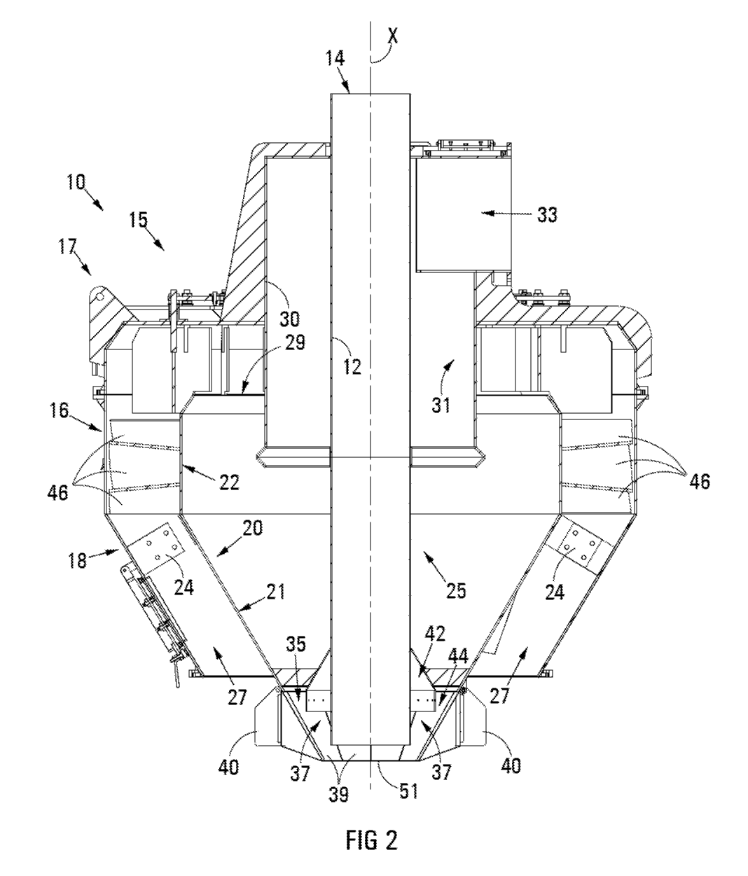

The classifier 10 further includes an internal housing 20 (see FIG. 2) which is concentrically arranged within the external housing about the inlet axis X. The feed pipe 12 is therefore arranged in the middle of the internal housing 20. The internal housing 20 includes a frusto-conical lower grit funnel 21 and a cylindrical wall 22 which is attached to the upper periphery of the frusto-conical grit funnel 21. The internal housing 20 is radially inwardly spaced from the external housing and held in place by braces 24 extending between the internal housing 20 and the external housing. The internal housing 20 defines an inwardly disposed classification zone 25 within which particulate material received into the internal housing 20 is classified. An airflow pathway 27 is defined between the internal housing 20 and the external housing, through which a pulveriser airstream containing crushed particulate material from the pulveriser is conveyed into the classification zone 25 of the internal housing 20 via an opening 29 defined by an upper periphery of the cylindrical wall 22 of the internal housing 20.

The classifier 10 further includes a cylindrical fuel outlet pipe 30 which is concentrically arranged about the feed pipe 12 and extends axially upward from the classification zone 25 defined by the internal housing 20 into the dome-shaped upper region 17 of the external housing. The outlet pipe 30 and the feed pipe 12 together define an annular fuel outlet passageway 31 which is in flow communication with the classification zone 25 of the internal housing 20. A lower periphery of the fuel outlet pipe 30 is axially inwardly disposed with respect to the upper periphery of the cylindrical wall 22. The classifier 10 further includes a fuel exit or outlet 33 leading from the annular fuel outlet passageway 31 whereby a fine fraction of the crushed particulate material is passed on to a furnace (not shown) for combustion.

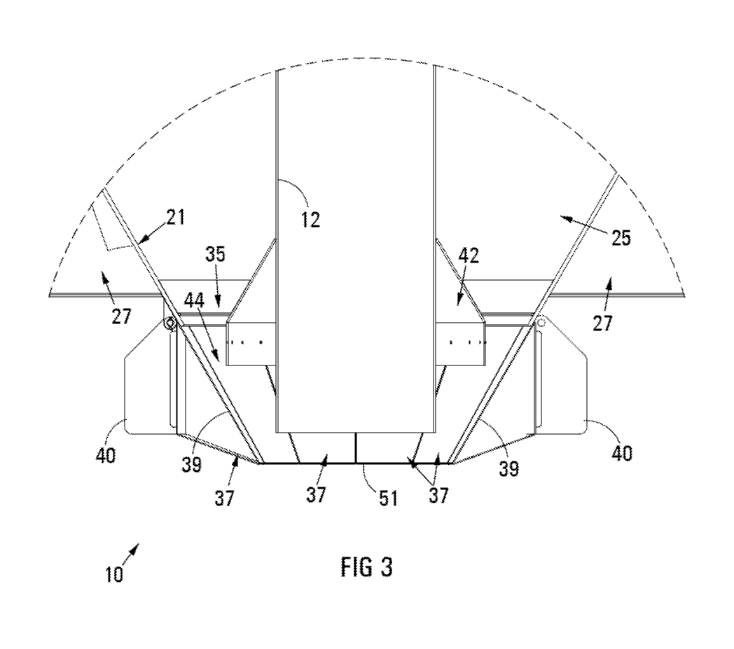

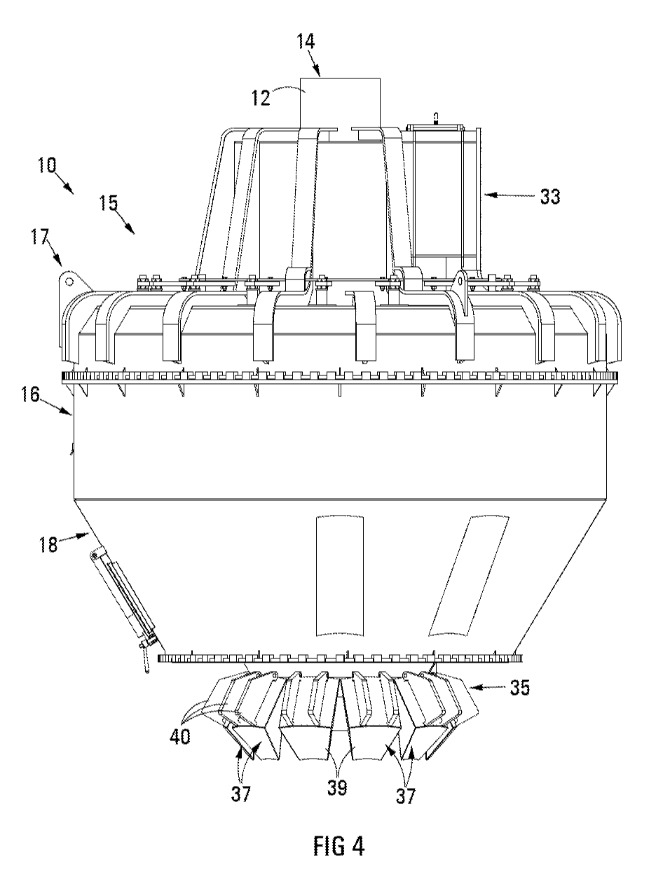

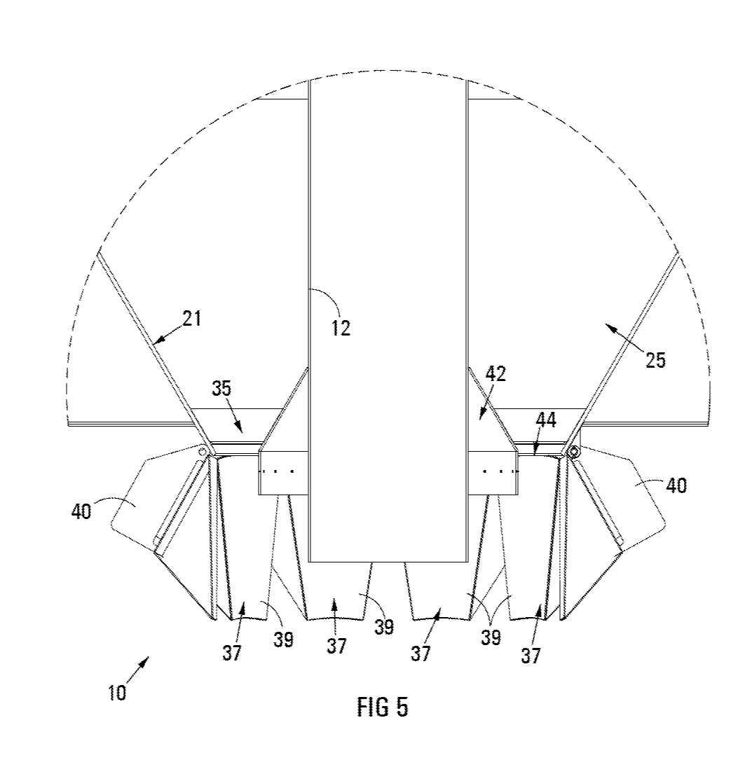

The classifier 10 has a rejection gate 35 toward an operatively lower end of the grit funnel 21. The rejection gate 35 includes a plurality of closure members 37 which are angularly spaced with respect to one another along a lower periphery of the grit funnel 21. Each closure member 37 includes a generally triangular flap 39 (see FIG. 3 and FIG. 5), one end of which is pivotally or hingedly attached to the grit funnel 21. Each closure member 37 has a wedge-shaped load-bearing face which operatively faces inward. Each closure member 37 further includes a pair of spaced apart counter weights 40, each of which have a trapezium-shaped profile in side view and are attached to a radially outwardly facing surface of the flap 39 (see FIGS. 1 and 4). The weights 40 extend lengthwise along the surface of the flap 39 and project radially outwardly from the flap 39. Each weight 40 has a slender transverse cross-sectional profile in order to minimise airflow restriction caused by the weights 40.

The closure members 37 of the rejection gate 35 are pivotally displaceable relative to the grit funnel 21 about separate pivot axes between a closed position, shown in FIGS. 2 and 3 and an open position shown in FIGS. 4 and 5. In the closed position, adjacent sides of the flaps 39 and load bearing faces are in abutment such that the load bearing faces of the closure members 37 together form a frusto-conical skirt which has a continuous lower periphery 51 and which forms an extension of the grit funnel 21. Owing to the weights 40, the weight distribution of each closure member 37 is such that it ordinarily hangs in the closed position when subject to gravity alone and no other external forces are applied to it.

The classifier 10 also includes a flange 42 which projects downwardly and outwardly from the feed pipe 12 in the region of the rejection gate 35. When the rejection gate 35 is closed an annular gap or rejection outlet 44 is formed between the gate 35 and the flange 42. The gap 44 is approximately 40 mm to 100 mm wide but may vary depending on the type of raw material being crushed.

A plurality of inclined guide vanes 46 are arranged between the cylindrical wall 22 of the internal housing 20 and the lower region 16 of the upper part 15 of the external housing. A thermal air current sweeps pulverised particulate material from the pulveriser into the classifier 10 and along the airflow pathway 27. As the air containing the suspended particles passes the inclined vanes 46 and enters the classification zone 25 via the opening 29, a centrifugal vortex is induced within the classification zone 25. Owing to the centrifugal forces created by the vortex, heavier, coarse particles are flung radially outwardly and slide down the grit funnel 21 toward the rejection gate 35. A fine fraction of the particles within the vortex is swept upward into the outlet passageway 31 and exits the classifier 10 via the fuel outlet 33.

A coarse fraction of the particles which have slid down the grit funnel 21 plug the gate 35 and close the gap 44 which prevents unwanted air flow into the classification zone 25 via the rejection gate 35. As the classification action continues, the gap 44 between the gate 35 and the flange 42 is quickly filled with the coarse fraction of the particulate material which is to be returned to the pulveriser for regrinding and material starts to build up within the internal housing 20. Under normal operating conditions an allowable level of material build-up is present inside the classification zone 25. The level of material inside the classifier 10 may rise to an undesirable level when a foreign object gets trapped inside the classifier 10 such that it obstructs the flow of material from the rejection gate 35. Once the weight of the material bearing down upon the flaps 39 exceeds the counter weight of the weights 40, the closure members 37 pivot radially outwardly toward their open position which widens the gap 44 and allows the material build up to exit the classifier 10 and return to the pulveriser. Once the material has passed, the closure members 37 return to the closed position owing to the weight of the weights 40.

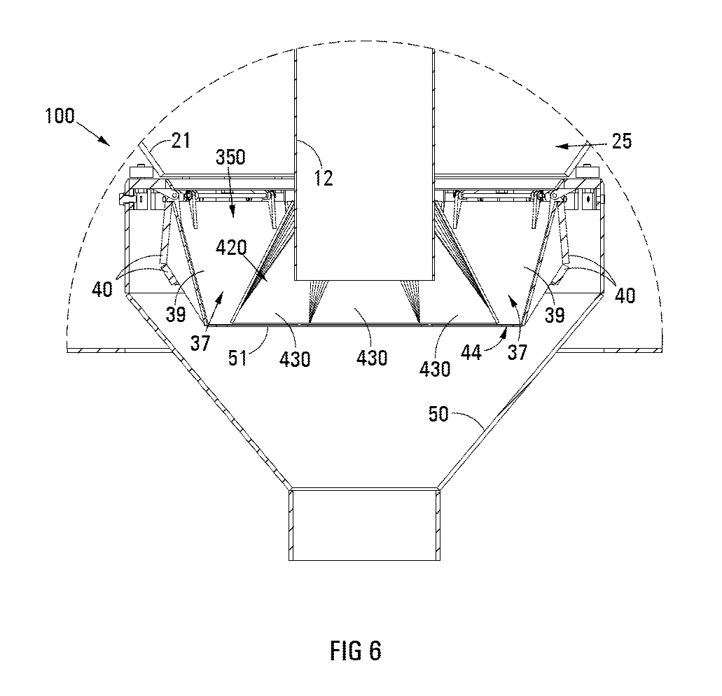

A second embodiment of a classifier in accordance with the invention is shown in FIG. 6 and is designated by reference numeral 100. The structure and principle of operation of the classifier 100 is essentially the same as the classifier 10 described above and a description of the structure and operation of the classifier 100 will therefore not be repeated here. The configuration of a rejection gate 350 of the classifier 100 varies slightly in comparison to the classifier 10. In FIG. 6 illustrating the classifier 100, the same reference numerals used above to identify features of the classifier 10 have been used to designate similar features of the classifier 100. The rejection gate 350 includes a plurality of closure members 37 which are arranged side-by-side around a lower periphery of the grit funnel 21 in similar fashion as the rejection gate 35. Each closure member 37 includes a generally triangular flap 39 to which weights 40 are attached. In this instance, the flange 420 comprises a number of angularly spaced, inclined panels 430 which project downwardly and outwardly from the feed pipe 12. In the closed position of the rejection gate 350 shown in FIG. 6, a continuous lower periphery 51 formed by the closure members 37 lies within the same horizontal plane as a lower periphery of the flange 420. A ring-like gap or rejection outlet 44 is formed between the flange 420 and the lower periphery 51 of the closure members 37. A hopper 50 is arranged below the rejection gate 350. As previously described, the closure members 37 hang in the closed position under the influence of gravity. As material builds up within the classification zone 25 owing to a blockage or obstruction, the weight of the material forces the closure members 37 to pivot radially outwardly which widens the gap 44 and allows the material to pass through the gate 350.

The invention extends to a method of modifying a conventional classifier used with a pulveriser, the method including retrofitting a plurality of closure members 37 as described above to a lower region of the classifier. The closure members 37 are retrofitted by hingedly or pivotally attaching each member 37 to a lower periphery of the grit funnel 21 of the classifier 10, 100. In order to accommodate the closure members 37 modifications may be made to the classifier 10, 100.

The Applicant believes that the rejection gate 35, 350, classifier 10, 100 and method of modifying a classifier as described above are an improvement on the prior art because the probability of the rejection gate 35, 350 becoming blocked by foreign objects is reduced because structural features such as partitions which could potentially obstruct the flow of material and foreign objects from the outlet 44 have been eliminated from the design. Accordingly, less blockages will occur which translates into less operational downtime and increased productivity and greater revenue.

1. A classifier for use with a pulveriser which pulverises raw material, the classifier being operable to classify crushed particulate material received from the pulveriser into a fine fraction which is expelled from the classifier and a coarse fraction which is returned to the pulveriser for further crushing, the classifier including:
an external housing;
an internal housing, disposed at least partially within the external housing, the internal housing defining an inward classification zone and further including:
an airflow inlet for receiving a pulveriser airstream containing crushed particulate material from the pulveriser into the classification zone;
at least one operatively upper exit; and
at least two articulated closure members which define a rejection outlet operatively below the exit, the classifier being configured to subject the pulveriser airstream to classification action within the classification zone such that a fine fraction of the pulveriser airstream is expelled from the classifier via the exit and a coarse fraction of the pulveriser airstream is rejected and returned to the pulveriser via the rejection outlet,
wherein the closure members are displaceable relative to the internal housing between:
a closed position in which the closure members are arranged alongside one another such that sides of adjacent closure members are in abutment and the closure members together define a depending skirt which has a continuous, operatively lower periphery and a cross-sectional area of the rejection outlet is at a minimum; and
an open position in which the sides of adjacent closure members are not in abutment and the cross-sectional area of the rejection outlet is increased.

2. A classifier as claimed in claim 1, which includes biasing means for biasing the closure members to the closed position.

3. A classifier as claimed in claim 2, wherein, the biasing means is in the form of a plurality of counter weights which are attached to the closure members and are configured to hold the closure members in the closed position when no other forces apart from gravity are applied to the closure members.

4. A classifier as claimed in claim 3, wherein each counter weight is attached to an operatively outer surface of one closure member, the counter weight extending lengthwise along the outer surface and having a slender transverse cross-sectional surface area in order to minimise air flow restriction.

5. A classifier as claimed in claim 4, wherein each closure member has a wedge-shaped load-bearing face which operatively faces inward.

6. A classifier as claimed in claim 5, wherein a wide end of the load-bearing face of each closure member is pivotally connected to a lower periphery of the internal housing, the closure members being outwardly pivotally displaceable relative to the internal housing, from the closed position to the open position, when a load of material having a weight which exceeds a predetermined threshold bears down upon the closure members.

7. A classifier as claimed in claim 6, wherein the closure members are angularly spaced relative to one another about a central axis.

8. A classifier as claimed in claim 7, wherein, in the closed position, the closure members are inwardly inclined such that the load bearing faces of the closure members give rise to a continuous skirt which exhibits a frusto-conical profile when seen in longitudinal cross-section.

9. A classifier as claimed in claim 8, wherein, in the closed position, sides of adjacent closure members form a seal between them.

10. A method of modifying a classifier for use with a pulveriser, the classifier being operable to classify crushed particulate material received from the pulveriser into a fine fraction which is expelled from the classifier and a coarse fraction which is returned to the pulveriser for further crushing, the classifier including:
an external housing;
an internal housing, disposed at least partially within the external housing, the internal housing defining an inward classification zone and further including:
an airflow inlet for receiving a pulveriser airstream containing crushed particulate material from the pulveriser into the classification zone;
at least one operatively upper exit; and
a rejection outlet, arranged operatively below the exit, the method including:
retrofitting at least two articulated closure members to a lower region of the classifier at or toward the rejection outlet, wherein the closure members are displaceable relative to the lower region of the classifier between:
a closed position in which the closure members are arranged side-by-side such that adjacent sides of the closure members are in abutment and a cross-sectional area of the rejection outlet is at a minimum; and
an open position in which the adjacent sides of the closure members are not in abutment and the cross-sectional area of the rejection outlet is increased.

11. A method as claimed in claim 10, which includes pivotally attaching each of the at least two closure members to a lower region of the classifier at or toward the rejection outlet.

12. A method as claimed in claim 10, which includes biasing the closure members toward their closed position by applying at least one weight to each articulated closure member.

13. A self-cleaning, load operated rejection gate for a particle classifier, the rejection gate being configured for connection to an operatively lower part of a particle classifier in a configuration in which the gate, together with the classifier, defines a rejection outlet, and in which the rejection gate is movable relative to the classifier between a closed position and an open position, the rejection gate including:
a plurality of closure members which, when the gate is in the closed position, are arranged alongside one another in a configuration in which:
sides of adjacent closure members are in abutment such that the closure members collectively define a depending skirt which has a continuous, operatively lower periphery; and
a cross-sectional area of the rejection outlet is at a minimum; and, when the rejection gate is in the open position, sides of adjacent closure members are not in abutment and the cross-sectional area of the rejection outlet is increased.
